(19) United States
(12) Patent Application Publication
(10) Pub. No.: US 2001/0021497 A1
(43) Pub. Date: Sep. 13, 2001

(54) Protective coverage of the operative dental instruments

(76) Inventor: Krystyna Roslan-Szulc, Gdansk-Zaspa (PL)

Correspondence Address: Horst M. Kasper, 13 Forest Drive, Warren, NJ, 07059, US

(21) Appl. No.: 09/754,796

(22) Filed: Jan. 4, 2001

(30) Foreign Application Priority Data
Jan. 12, 2000 (PL) P337833

(51) Int. Cl. A61C 1/16

(52) U.S. Cl. 433/116

(57) ABSTRACT

The protective coverage of the operative dental instruments is made from thermoshrinkable foil. Its form is the elongated elastic sleeve (1) with an elliptical cross-section before application. Its surfaces both frontal and lateral are parallel to the covered surfaces of the protected dental instrument (2). The positive dimensional tolerance 1-20% is maintained, ensuring the easiness of insertion and tight adherence of the thermoshrinkable foil to the covered surfaces, after low-intensity warming. The protective coverage secures the covered surfaces against any biological contamination, for example blood or saliva, thus protecting the patient as well as a dentist.

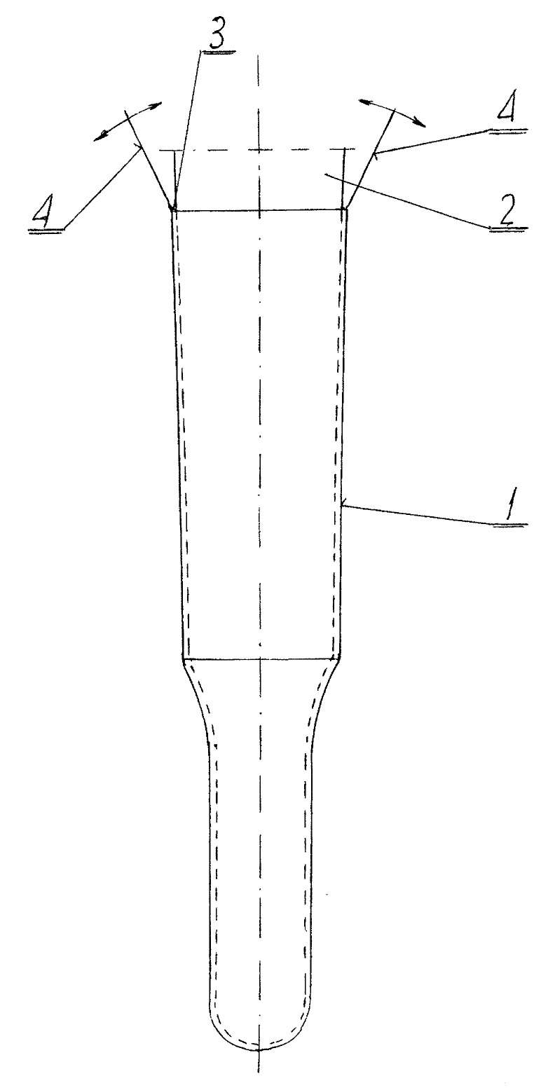

A subject of the invention is the protective coverage of operative dental instruments, which is an expandable protective sleeve of a dental tool holder during a dental procedure.

This matter is known from a specification of utility pattern Nr Ru 52096 that resolves a problem of single-use container, which protects the operative dental instruments. This is a cylindrical sleeve with a larger inner diameter than the protected instrument, having an arch-like end in its top part and an inserting hole in its bottom part. There is a shrinking element which is set outside an edge of the inserting hole and which is fixed on the lateral surface of the cylindrical sleeve.

The inconvenience of this solution is the difficulty in the possibility to obtain in a specific time a tight adherence of foil with the protecting surface, having the cranks and the cavities or the significant difference of diameters. The reason is that the uniform cylindrical sleeve, having a specified degree of shrinkage, does not always adherent to the surface sufficiently.

The essence of the solution by the present invention is a construction of the protective covering at the operative dental instruments, COVERDENT, which is made from a thermoshrinkable material. The characteristic of this cover is its form of the elongated elastic sleeve with an elliptical cross-section before application. Its surfaces, both frontal and lateral, are parallel to the covered surfaces of the protective dental instrument, simultaneously holding the positive dimensional tolerance in compliance with the dimensions of the covering surface of the protected dental instrument.

There is an axis cutting through its lateral side in the plane of roll creating the flat symmetrical hinged ends, in the elongated elastic sleeve, from the side of the inserting hole.

In the solution, the present invention has obtained the special advantage and unnoticeable effect in the configuration of the surfaces, both frontal and lateral, of the elongated elastic sleeve, parallel to the covered surfaces of the protected dental instrument. The positive dimensional tolerance 1-20% is maintained, ensuring, after the low-intensity warming, the tight adherence of the thermoshrinkable foil with the covered surfaces, independently of the dimensions and the sections of the cavities and the projections or independently of the changing surfaces of the dental instrument holder. The coverage, which is used in this way, secures the covered surface against any biological contamination, for example blood or saliva, thus protecting the patient as well as the dentist.

The symmetrical hinged ends, which are placed at the inserting hole on the lateral surface of the elongated elastic sleeve, create possibility after the operation of easy removal of the elastic, coverage from the instrumental surface by wrapping the infecting surface into the interior of the sleeve. Then it must be ejected to a dustbin in order to be burned.

The present resolve is characteristic of the simple construction, easy technology of the making, and is possible to create the forms which are well fitting to the currently known dental device constructions. The contingency of the protection by the cover dental operation instruments, which should not be separated from a main assembly of the devices in order to sterilize them completely, is a very important quality of the resolve by the present invention. It may be the consequence of construction and contents of the electromagnetic elements, for example, the small-power motors with a handle, the chip-blowers, a handle of piezodent, a haloid lamp, an intraoral chamber, a panoramic roentgen apparatus, and so on.

The easiness in employment of the COVERDENT, which does not require the special instrumentation, is the essential advantage of this invention. The high technical and useful quality creates the good circumstances of the extensive utilization of this COVERDENT by dentists, warranting that any infection of the patients as well as the dentists and nursing staff will not take place. It applies to the circumstances of the small dentists' offices and the hospitals and clinical treatment rooms alike.

The resolve of this invention can be employed also in the other branches of medicine, for example, in the traumatic surgery, urology, and gynecology.

The subject of this invention is shown on a FIGURE, which is a schema of the protective cover of the dental operative instruments with a contra-angle handpiece with a small-power motor located in its interior.

The protective coverage of the operative dental instruments COVERDENT is made from thermoshrinkable foil and its form is the elongated elastic sleeve 1 with an elliptical crass-section before application. Its surfaces both frontal and lateral are parallel to the covered surfaces of the protective dental instrument 2, seated inwards by the inserting hole 3. The dimensional diameter tolerance of the elongated elastic sleeve 1 is contained within the range of 1-20% in compliance with the diameter's dimensions of the covered surface of the protected dental instrument 2. There is an axis cutting through its lateral side in the plane of roll creating the flat symmetrical hinged ends 4, in the elongated elastic sleeve 1, from the side of the inserting hole 3.

Usually the protective covering of the operative dental instruments by this invention, COVERDENT is used as follows. The selected elongated elastic cover 1 is put on the protective dental instrument. 2 by the inserted hole 3, ensuring the tight adherence of the frontal arched surface to the end of the protected dental instrument 2. This instrument can be a handpiece or a contra-angle handpiece together with a small-power motor, a turbine contra-angle handpiece, a chip-blower, a piezodent end-part, or a haloid lamp end-part.

If some contra-angle handpieces are used, it is indispensable to open a surgical elevator holding a dental bur. Then we set the prepared in this way assembly over a source of heat. A boiler-scaling hammer is used in this order. The foil shrinks exactly, safely and quickly, tightly adhering to the surface of the protective dental instrument. As a source of heat may be used also a flame cone of a spirit or gas lamp /˜200″C/, above which a screwing motion is performed in a distance 5-1 cm, simultaneously moving it in plane of the protective cover's roll axis. Then we gut the dental bur in the protected dental instrument 2 with the placed and shrinked elongated elastic cover 1, previously cutting a hole. If a high-speed dental drill is used or any other end-parts with the service-pipe of water, we cut the foil out the larger or added hole, for water's outflow.

The length of elongated elastic cover 1 is fitted in such a way that gripping an instrument firmly several times in the time of procedure this instrument will not infect. After we completed our work with the patient, we take off elongated elastic cover 1, wrapping the flat. symmetrical hinged ends 4, moving then forward and hiding the infected surfaces inward. Then we place the utilized elongated elastic cover 1 in 5% chloramine solution or any other disinfectant for 1 hour. After this we place it with other infected materials for burning. If possible, after the elongated elastic cover 1 is taken off, we sterilize the protected dental instrument 2 thermally or chemically. The above functions diminish the risk of transmission of hepatitis viruses, AIDS, or other communicable diseases.

1. The protective covering of operative dental instruments, COVERDENT is made from a thermoshrinkable material and is unique by its form of an elongated elastic sleeve 1, with an elliptical cross-section before application. Its surfaces, both frontal and lateral, are parallel to the covered surfaces of the protected dental instrument 2, simultaneously holding the positive dimensional tolerance within the range of 1-20% in compliance with the dimensions of the covered surface of the protected dental instrument 2. There is, an axis cutting through its lateral side in plane of roll, of some length, creating the flat symmetrical hinged ends 4, in the elongated elastic sleeve 1, from the side of the inserting hole 3.
